(19) United States
(12) Patent Application Publication
(10) Pub. No.: US 2010/0189511 A1
(43) Pub. Date: Jul. 29, 2010

(54) DRY ACID SOIL TREATMENT COMPOSITION

(75) Inventors: Kevin S. Spittle, Vero Beach, FL (US); Allen B. Olson, Flower Mound, TX (US)

Correspondence Address: BROOKS KUSHMAN P.C., 1000 TOWN CENTER, TWENTY-SECOND FLOOR, SOUTHFIELD, MI, 48075, US

(73) Assignee: PROFILE PRODUCTS LLC, Buffalo Grove, IL (US)

(21) Appl. No.: 12/696,462

(22) Filed: Jan. 29, 2010

Related U.S. Application Data
(60) Provisional application No. 61/148,272, filed on Jan. 29, 2009.

(51) Int. Cl. B09C 1/08; C05F 11/00

(52) U.S. Cl. 405/128.75; 71/11

(57) ABSTRACT

According to one aspect of the present invention, a soil treatment composition is provided. In one embodiment, the soil treatment composition includes an acidic material containing at least one organic acid and at least one inorganic acid, and a plurality of substrate particles supporting the acidic material. In another embodiment, the substrate particles are sized to be retained on a 100 mesh sieve. In yet another embodiment, the organic acid includes an oxalic acid, a citric acid, or combinations thereof. In yet another embodiment, the soil treatment composition further includes a soil/plant nutrient material.

### CROSS-REFERENCE TO RELATED APPLICATION

This application claims the benefit of the U.S. Provisional Application No. 61/148,272 filed Jan. 29, 2009.

### BACKGROUND

1. Technical Field

One or more embodiments of the present invention relate to a soil treatment composition and a method of using the same.

2. Background Art

Most soil is irrigated with hard water containing high calcium levels. Hard water is an issue in approximately 50% of the states in the U.S. and particularly the midwest, southwest and western states. Over time the soil irrigated with hard water forms sodium bicarbonate which increases the alkalinity of the soil's pH (pH>9). In addition the sodium carbonate interacts with calcium chloride ions in the water to produce free sodium ions, sodium chloride and calcium carbonate (limestone). The free sodium ions then binds with clay particles which exchange calcium ions for sodium ions to reduce available sodium causing the soil to swell. These clay materials which are fully saturated with sodium are called bentonite. Highly alkaline or sodic soils may be reclaimed by adding acidifying chemicals and soil nutrients.

In order to combat the affects of hard water and high alkaline soil, acidic (pH 1-4) chemical compounds containing soil nutrients are used to facilitate the right balance of sodium and calcium ions in the soil, generally a pH of 6.0 to 6.5. However, in high humidity areas, locations with heavy rainfall or locations where regular irrigation occurs, these products are rapidly diluted, which reduces the benefits of the acid treatment. Some acid treatment compounds increase the amount of nitrogen to provide a quick boost in the amount of sodium and calcium released. This benefit is short lived and can cause a boomerang effect on soil pH resulting in only moderate reductions in alkalinity. It is also recommended calcium be added to supply a source of calcium ions to balance the sodium and facilitate release of calcium from limestone.

Liquid acid soil treatment formulations when prepared in solution generally have a reduced shelf life and require adequate mixing to ensure delivery of the appropriate concentration of the soil treatment. These products are generally sprayed on the treated area. Liquid acids are corrosive and therefore difficult to control and hazardous to handle for larger applications. Also, as dilution is required for spot treatment, miscalculation may result in burn spots on grass and turf surfaces. In addition, sulfur burners may be utilized to treat enclosed areas and SO₂ generators maybe utilized at the point of origin of the water irrigation system. The former is limited to mostly enclosed areas and the latter is an expensive water treatment system.

Thus, there is a need for a soil treatment composition which is cost-effective, does not require dilution and which is able to reduce the alkalinity of the soil for an extended period of time to facilitate restoration of soil nutrition.

### SUMMARY

According to one aspect of the present invention, a soil treatment composition is provided. In one embodiment, the soil treatment composition is provided for the treatment of highly alkaline soil wherein the soil treatment composition contains porous and/or non-porous ceramic particles into and/or onto which at least one liquid acid is absorbed or adsorbed. The acid and ceramic particles may be dried to a low moisture content. These dry acid treated particles may be combined with other soil nutrients to promote the proper soil environment for intended agricultural, recreational or landscaping applications.

### DETAILED DESCRIPTION

Detailed embodiments of the present invention are disclosed herein; however, it is to be understood that the disclosed embodiments are merely exemplary of the invention that may be embodied in various and alternative forms. Therefore, the description is merely a representative basis for the claims and/or as a representative basis for teaching one skilled in the art to variously employ the present invention.

According to one aspect of the present invention, a soil treatment composition is provided. In one embodiment, the soil treatment composition includes an acidic material containing at least one organic acid and at least one inorganic acid, and a plurality of substrate particles supporting the acidic material to form a supported acidic material. In another embodiment, the soil treatment composition further includes a soil nutrient material intermixed with the supported acidic material to form the soil treatment composition. As will be described in more detail shown below, the acidic material can be provided in a solution for application to the substrate particles and can be dried thereafter for enhanced adhesion and/or absorption onto the substrate particles. When the acidic material contains more than one acid type, each acid can be prepared singly or in combinations and can be applied to the substrate particles singly or in combination.

In one or more embodiments, the term “soil” refers to all soil layers on the ground. Of the soil layers, topsoil refers to the upper, outermost layer of the soil having a thickness of 0.5 to 15 inches, 1.0 to 12 inches, or particularly 2 to 8 inches. The topsoil usually contains a relatively high concentration of organic matter and microorganisms. Topsoil erosion occurs when the topsoil layer is blown or washed away. Without topsoil, little plant life is possible.

In yet another embodiment, the inorganic acid is selected from the group consisting of a hydrochloric acid, hydrobromic acid, sulfuric acid, nitric acid, phosphoric acid, a boric acid, a hydrofluoric acid, and combinations thereof. In yet another embodiment, the organic acid is selected from the group consisting of an acetic acid, citric acid, formic acid, gluconic acid, lactic acid, oxalic acid, tartaric acid, a uric acid, and combinations thereof. In one or more embodiments, the organic acids are any suitable conventionally known carboxylic acids that are generally weaker acids than the inorganic acids or mineral acids. In certain instances, the organic acid includes an oxalic acid. In certain other instances, the organic acid includes an oxalic acid and a citric acid. In yet certain other instances, the organic acid includes an oxalic acid and the inorganic acid includes a sulfuric acid, a phosphoric acid, a hydrochloric acid, or any combinations thereof. In yet certain other instances, the organic acid includes an oxalic acid and a citric acid, and the inorganic acid includes a sulfuric acid, a phosphoric acid, a hydrochloric acid, or any combinations thereof.

In yet another embodiment, the substrate particles include ceramic particles. The ceramic particles may be formed of any conventional ceramic material, preferably one of ready availability and low cost. Non-limiting example of the ceramic material includes montmorillonite, bentonite, vermiculite, perlite, or mixtures thereof.

In yet another embodiment, the plurality of substrate particles, optionally made of the ceramic material, may be porous, non-porous, or of a combination thereof. In certain instances, the substrate particles are made of porous particles, and ceramic porous particles in certain particular instances. Without being limited to any particular theory, it is believed that the acidic material can be present both on the outer surfaces and inner pore surfaces of the substrate particles when the particles are relatively more porous. For the substrate particles being relatively less porous, alternatively called the non-porous particles, the majority of the acidic material remains on the outer surfaces of the non-porous particles.

In one or more embodiments, the term porosity refers to a measure of the void spaces created by the pores in the substrate particles and is a fraction of the volume of the voids over the total volume of the substrate particles. The porosity is a value of from 0 to 1, or a percentage of from 0% to 100%.

In yet another embodiment, substrate particles are porous particles having a porosity of from 10 to 90 volume percent, 20-90 volume percent, or 30-95 volume percent. In certain instances, the plurality of substrate particles is provided with a porosity of from 64 to 85 volume percent. Increased porosity generally helps to provide greater surface areas for supporting the acidic material. However, too much porosity may cause the substrate particles to be unnecessarily fragile and more prune to compression. Therefore, a particular range of porosity should be selected based on the particular usage at hand.

An example of the porous particles is commercially available under the trade name of “Profile Porous Ceramic particles” from Profile Products, LLC of Buffalo Grove, Ill. These porous ceramic particles are clay-based montmorillonite mined from Blue Mountain, Miss. and fired to 1000° C. to make a porous ceramic particle. The Profile Porous Ceramic particles have originally been developed to be an inorganic soil treatment to preserve water and oxygen flow to plant root systems in easily compacted soil. For example, U.S. patent application Ser. No. 11/619,831, for a “biological soil nutrient system” describes the porous ceramic particles in a soil nutrient system involving microorganisms. This application is herein incorporated by reference.

In yet another embodiment, the substrate particles are non-porous particles having a porosity of less than 10 volume percent, 8 volume percent, 6 volume percent, 4 volume percent, or volume percent. Non-limiting examples of the non-porous particles include sand, silica, beach stones, and combinations thereof.

In yet another embodiment, the substrate particles are sized to pass through a 24 mesh sieve having a sieve opening size of from 0.690 mm to 0.720 mm, through a 30 mesh sieve having a sieve opening size of from 0.585 mm to 0.605 mm, through a 40 mesh sieve having a sieve opening of from 0.410 to 0.430 mm, or through a 50 mesh sieve having a sieve opening of from 0.287 mm to 0.307 mm. In yet another embodiment, the substrate particles are sized to be retained by a 100 mesh sieve having a sieve opening size of from 0.139 mm to 0.159 mm, or by a 80 mesh sieve having a sieve opening size of from 0.167 mm to 0.187 mm. In certain instances, the substrate particles are sized to pass through a 24 mesh sieve but are retained by a 48 mesh sieve. Larger or smaller particle sizing facilitates targeted calculation of acidification rates and required amounts of product per cubic foot. In certain particular instances, the particles are sized to pass through a 24 mesh sieve but are retained on a 100 mesh sieve (0.152 mm). Smaller particle sizes may relate to a decrease of the surface area for supporting the acidic material. The decrease in particle surface area usually reduces the amount of dry acid/square foot. In certain particular instances, the substrate particles are sized to be retained by a 100 mesh sieve. Without being limited to any particular theory, the substrate particles and particularly porous substrate particles are more effective in facilitating water and/or oxygen permeation and enhancing the delivery of the acidic material into the soil when the substrate particles are provided with certain particle sizes, for instance when the substrate particles are sized to be retainable by a 100 mesh sieve.

In yet another embodiment, the acidic material is applied to the substrate particles in the form of a solution to provide even distribution and an ease of care. The acidic material in the form of a solution can be sprayed onto the substrate particles or the substrate particles can be dipped or submerged into the solution to obtain an even coating of the acidic material. In the case of reasonably porous ceramic particles, following addition of the acidic material, the particles may appear to be dry. However, the thus treated particles, whether dry-appearing or moist-appearing, may still be further dried by conventional techniques.

In yet another embodiment, a solution of the acidic material is applied to the porous ceramic particles and gets dried and thereafter absorbed onto the substrate particles. The solution of the acidic material may be added at a ratio of 15-20 gallons per ton, or preferably, 18 gallons per ton of the substrate particles such as porous ceramic particles. The acidic material can be applied to the substrate particles in any suitable weight ratio based on dry weight. In certain instances, a weight ratio of the acidic material to the substrate particles based on dry weight is from 0.1% to 15%, 1% to 10%, 2% to 7%, or 3% to 5%.

An example of the solution of the acidic material may be prepared to have the ingredients tabulated in Table 1:

TABLE 1
list of ingredients of a sample acidic material

| | TARGET | |
|---|---|---|
| CONCENTRATED ACID | % BY WEIGHT | RANGE |
| Hydrochloric acid (HCl) | 1.35% (0.45%-2.25%) | (0.00%-5.00%) |
| Phosphoric acid (H₃PO₄) | 1.35% (0.45%-2.25%) | (0.00%-5.00%) |
| Oxalic acid (H₂C₂O₄) | 0.27% (0.09%-0.45%) | (0.00%-1.00%) |
| Citric acid (C₆H₈O₇) | 0.09% (0.01%-0.15%) | (0.00%-1.00%) |

The acidic material may be added to the substrate particles by any suitable methods which may include the use of tumblers, heat beds, spin-driers or spray drying equipment. The finished product should preferably have a moisture content between 0 and 12%, preferably less than 9%. Minerals and soil nutrients may preferably be added to the acidic material containing porous ceramic particles preferably in a ratio of 1:20. The range may be adjusted from 1:20 to a 20:1 ratio of nutrients to the acidic material containing porous ceramic particles depending upon the amount required to reduce alkalinity of the soil to a target pH. The soil treatment composition may be packaged and is stored without the usual problems associated with handling corrosive liquid acid products.

It has been found, according to one or more embodiments of the present invention, the soil treatment composition as applied to the soil makes the soil more chemically conductive to plant growth, reduces certain unwanted ions or chemicals such as sodium and bicarbonates in soil, and/or improves root development of the plants grown on the soil. Without being limited to any particular theory, it is believed that the acidic material present in the soil treatment composition beneficially modifies the soil particularly by neutralizing alkaline chemicals such as bicarbonates in the soil. Without being limited to any particular theory, it is also believed that the acidic material as released into the soil helps to solubilize calcium by reacting to calcium bicarbonate; in turn, the solubilized calcium is then available to displace sodium which is generally bad for soil.

Without being limited to any particular theory, it is believed that the corrosiveness of the inorganic acid is neutralized or masked by the concurrent inclusion of the organic acid with the inorganic acid in the acidic material wherein the hydrogen atoms dissociated from the stronger inorganic acid such as hydrochloric acid are at least partially sequestered by the relatively weaker organic acid such as oxalic acid. Containing both the at least one organic acid and at least one inorganic acid, the acidic material is relatively less corrosive and hence relatively safer for handling.

Without being limited to any particular theory, it is believed that the acidic material present in the soil treatment composition can be configured to be released in a controlled manner such that admission of the acidic material into the soil can be time-controlled. By way of example, the substrate particles can be formed of sub-groups of particles having different porosity and/or different particle sizes such that the portion of the acidic materials present in pores having relatively bigger pore sizes may be released more freely and earlier in the process.

It has been found, in one or more embodiments, the acidic material as supported on the plurality of substrate particles can be made relatively dry, for instance, to have a moisture content of no greater than 12 weight percent, 9 weight percent, 6 weight percent, 3 weight percent, or 0.5 weight percent. When in the relatively dry form, for instance when having a moisture content of less than 0.5 weight percent, the soil treatment composition containing the acidic material can be handled with more ease and less concerns for acidic corrosion. This arrangement presents a departure from conventional raw sulfur powders, the use of which often involves substantial risk of corrosion attack due to inhalation and direct skin contact.

In yet another embodiment, the soil treatment composition further includes a soil nutrient material. The soil nutrient material may be added to and be combined with the acidic material-containing substrate particles prior to admission to the soil or may be added to the soil before, during, and after the admission to the soil of the acidic material-containing substrate particles. Without being limited to any particular theory, the soil nutrient material helps to replenish loss of soil nutrients that may have been lost over time due to factors such as improper fertilization.

In one or more embodiments, the macro-nutrient refers to elements that are usually lacking from the soil because plants use large amounts for their growth and survival. In certain instances, the macro-nutrient includes nitrogen (N), phosphorus (P), potassium (K), calcium (Ca), magnesium (Mg), sulfur (S), or combinations thereof. In one or more embodiments, the micro-nutrient refers to elements that are essential for plant growth and are needed in only very small quantities. In certain instances, the micro-nutrient includes boron (B), copper (Cu), iron (Fe), chloride (Cl), manganese (Mn), molybdenum (Mo), zinc (Zn), or combinations thereof. In one or more embodiments, the soil nutrient material includes a biological organic matter such as humic acid (humus), straw, hay, mulch fibers to promote the growth of grass and plants; or combinations thereof. One skilled in the agricultural arts is aware of the types and amounts of macro and micronutrients and other soil additives.

A non-limiting example of a soil treatment composition is provided with ingredients tabulated in Table 2.

TABLE 2
list of ingredients of a sample soil treatment composition
Ingredients

Acids: hydrochloric acid, phosphoric acid, oxalic acid, citric acid
Particles: porous ceramic particles
Soil Macro-Nutrients: phosphorus, magnesium, and potassium

According to one aspect of the present invention soil aeration is the soil delivery method for the dry acid treatment composition. In the field of soil biology, aeration of the soil is necessary for successful soil management and growth of plants. Aeration ensures the root systems have adequate access to air and water. The grounds maintenance industry utilizes different types of equipment to promote aeration of the soil. An industry leader in the field of grounds maintenance developed the DryJect (™) system which is manufactured by DryJect Manufacturing, LLC in Hatboro, Pa., a Profile Products, LLC company. This hydro injection system is utilized to relieve soil compaction which stifles root systems and reduce standing water on the surface of the lawn and/or turf. The DryJect (™) equipment uses water to fracture the soil with the capability of simultaneously injecting large volumes of dry fertilizers, inorganic soil treatments and pesticides that allow golf courses, and similar surfaces, to be usable in one hour after treatment.

In another embodiment, the soil treatment composition is distributed onto the topsoil prior to sod and turf planting. This is alternatively named as “top dressing.”

In yet another embodiment, the soil treatment composition is distributed to an aerated soil area that has been previously treated by aeration. Soil aeration may include spike aeration wherein soil is punctured with spikes using mechanical equipments, or core aeration wherein cores of soil are removed from the ground to improve water and soil nutrients infiltration and enhance grass seed germination. The depth of aeration is preferably from 1.0 to 5.0 centimeters (cm). The soil treatment composition may be deposited to an aeration depth of from 5.0 to 25 cm to ensure coverage of the topsoil layer.

In yet another embodiment, the soil treatment composition is delivered to the soil by a hydro injection system. Without being limited to any particular theory, it is believed that the hydro injection system employs water to produce a high pressure aeration hole approximately ¼ by ½ inch wide (0.64-1.27 centimeters) and from 2-10 inches deep (5.04-25.4 centimeters). The penetrating force of the hydro injection system permits the insertion of the soil treatment composition to the appropriate topsoil depth. The aeration is very temporary and the aeration holes close after a short time. The delivery system is currently available for use with conventional inorganic porous ceramic particles but the new use for the system as a delivery vehicle for soil treatment compositions is expected to revolutionize turf and lawn maintenance as well as enhance other agricultural soil nutrient processes.

The treatment area is prepared for aeration and the equipment is calibrated to the appropriate depth. In one or more embodiments, the amount of the soil treatment composition required is approximately 50 lbs to 250 lbs per 1,000 square feet, particularly 100 lbs to 200 lbs per 1,000 square feet, or more particularly 125 lbs to 175 lbs per 1,000 square feet. A non-limiting example amount of soil treatment composition required is about 150 lbs per 1,000 square feet. The hydro injection system is loaded with the amount of the soil treatment composition for the treatment area and initiates delivery to the soil.

The use of a hydro injection system is the preferred method for delivery of the soil treatment composition. According to another aspect of the present invention another delivery method which may be employed, is a manual method of delivery using a spiked mechanism to produce the aeration holes. The soil treatment composition is placed into the holes by raking manually and is an effective method with smaller areas such as gardens and smaller lawns.

In soil applications with no vegetative cover, or a vegetative cover which is no longer desired, the soil treatment composition may be spread or distributed on the surface of the soil by conventional methods and tilled into the soil. When sod is to be placed or other cover is to be grown immediately, merely distributing the soil treatment composition on the surface prior to laying sod or seeding may be satisfactory.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed:

1. A soil treatment composition comprising:
an acidic material including at least one inorganic acid and at least one organic acid; and
a plurality of substrate particles supporting the acidic material.

2. The soil treatment composition of claim 1, wherein the at least one organic acid is selected from the group consisting of an oxalic acid, an acetic acid, a citric acid, a formic acid, a gluconic acid, a lactic acid, a tartaric acid, a uric acid, and combinations thereof.

3. The soil treatment composition of claim 1, wherein the at least one organic acid includes an oxalic acid and a citric acid.

4. The soil treatment composition of claim 1, wherein the at least one inorganic acid is selected from the group consisting of a hydrochloric acid, a hydrobromic acid, a sulfuric acid, a nitric acid, a phosphoric acid, a boric acid, a hydrofluoric acid, and combinations thereof.

5. The soil treatment composition of claim 1, wherein the at least one inorganic acid includes a hydrochloric acid and a phosphoric acid.

6. The soil treatment composition of claim 1, wherein the at least one organic acid includes an oxalic acid and the at least one inorganic acid includes a sulfuric acid.

7. The soil treatment composition of claim 1, wherein the plurality of substrate particles include ceramic particles.

8. The soil treatment composition of claim 1, wherein the plurality of substrate particles are sized to be retained by a 100 mesh sieve.

9. The soil treatment composition of claim 1, wherein the plurality of substrate particles are sized to pass a 24 mesh sieve.

10. The soil treatment composition of claim 1, wherein a weight ratio of the acidic material to the plurality of substrate particles is of from 0.1 weight percent to 15 weight percent based on dry weight.

11. The soil treatment composition of claim 1, wherein a weight ratio of the acidic material to the plurality of substrate particles is of from 3 weight percent to 5 weight percent based on dry weight.

12. The soil treatment composition of claim 1, further comprising at least one soil nutrient material selected from the group consisting of a micro-nutrient, a macro-nutrient, a biological nutrient, and combinations thereof.

13. The soil treatment composition of claim 1, wherein the substrate particles have a porosity of less than 10 volume percent.

14. The soil treatment composition of claim 1, wherein the substrate particles have a porosity of from 10 volume percent to 90 volume percent.

15. A soil treatment composition comprising:
an acidic material including at least one inorganic acid and at least one organic acid;
a plurality of substrate particles supporting the acidic material; and
at least one soil nutrient material selected from the group consisting of a macro-nutrient, a micro-nutrient, a biological nutrient, and combinations thereof.

16. The soil treatment composition of claim 15, wherein the plurality of substrate particles are sized to be retained by a 100 mesh sieve.

17. The soil treatment composition of claim 15, wherein the at least one organic acid includes an oxalic acid.

18. The soil treatment composition of claim 17, wherein the at least one inorganic acid is selected from the group consisting of a hydrochloric acid, a hydrobromic acid, a sulfuric acid, a nitric acid, a phosphoric acid, a boric acid, a hydrofluoric acid, and combinations thereof.

19. The soil treatment composition of claim 17, wherein the at least one organic acid further includes a citric acid.

20. The soil treatment composition of claim 19, wherein the at least one inorganic acid includes a hydrochloric acid and a phosphoric acid.

21. The soil treatment composition of claim 15, wherein the plurality of substrate particles include ceramic particles.

22. The soil treatment composition of claim 15, wherein a weight ratio of the acidic material to the plurality of substrate particles is of from 0.1 weight percent to 15 weight percent based on dry weight.

23. A method for treating a soil, comprising:
contacting the soil with a soil treatment composition, the soil treatment composition including an acidic material containing at least one organic acid and at least one inorganic acid, and a plurality of substrate particles supporting the acidic material.

24. The method of claim 23, further comprising, prior to the contacting step, the step of providing the soil treatment composition which includes contacting the plurality of substrate particles with the acidic material to form a supported acidic material.

25. The method of claim 23, wherein the step of providing further comprises drying the supported acidic material to have a moisture content of less than 10 weight percent of water.

26. The method of claim 23, wherein the step of providing further comprises adding a soil nutrient material into the supported acidic material.

27. The method of claim 23, further comprising, prior to the step of contacting, the step of aerating the soil.

28. The method of claim 27, wherein the step of contacting is carried out by spraying.

29. The method of claim 23, further comprising, prior to the step of contacting, the step of isolating an area of the soil to form a localized soil area, and contacting the localized soil area with the soil treatment composition.
